(19) United States
(12) Patent Application Publication
(10) Pub. No.: US 2003/0183136 A1
(43) Pub. Date: Oct. 2, 2003

(54) Hidden drawer safe

(76) Inventor: Daniel D. Perkins, Memphis, TN (US)

Correspondence Address: Robert M. Downey, ROBERT M. DOWNEY, P.A., Suite 350, 150 E. Palmetto Park Road, Boca Raton, FL, 33432, US

(21) Appl. No.: 10/395,943

(22) Filed: Mar. 24, 2003

Related U.S. Application Data
(63) Continuation-in-part of application No. 10/033,866, filed on Dec. 19, 2001, now abandoned.

(51) Int. Cl. E05G 1/00

(52) U.S. Cl. 109/47

(57) ABSTRACT

A sliding drawer received within a housing includes a front panel for covering an open end of the housing when the drawer is closed. A catch pin is urged to a normally extended position to engage an aperture in a tab on the back of the drawer in order to hold the drawer closed and locked. A key operated switch provides power from a battery power source to a push button switch which is operable to close a circuit and deliver electric power to a solenoid mounted within the housing. Activation of the solenoid causes the catch pin to momentarily retract and release the drawer from the locked position. Once released, a spring urges the drawer outwardly to an open position, thereby providing access to contents stored in the drawer. Subsequent movement of the drawer to the closed position compresses the spring and engages the catch pin with the tab on the back end of the drawer to hold the drawer in the locked position.

This application is a continuation-in-part of co-pending patent application Ser. No. 10/033,866 filed on Dec. 19, 2001, the contents of which are incorporated herein by reference.

### BACKGROUND OF THE INVENTION

1. Field of the Invention

The present invention is directed to safes for holding valuables and other articles and, more particularly, to a safe comprising a housing and a sliding drawer, and wherein the safe is adapted to be installed in a manner which hides the housing and front face of the drawer from normal view.

2. Discussion of the Related Art

It is estimated that over a period of 25 years, four out of every five homes are burglarized. Even homes with security systems are not safe from burglary, as thieves can break into a home, steal valuables, and be gone before the police can respond to an alarm. Unfortunately, the thieves in most home burglaries are never apprehended.

In order to prevent theft of valuables such as jewelry, money, art, etc., some homeowners install one or more safes in their home. Typically, a safe is installed in a wall, often in the closet. And, while a safe can be a useful security device for protecting valuables, having one in the home can sometimes leave the homeowner with a false sense of security. Most professional burglars know exactly where safes are installed within a home and can usually break into them in a manner of minutes. Even an amateur thief can break into some wall safes given sufficient time. A bigger problem arises if a homeowner is victimized by a home invasion, a crime which is becoming increasingly prevalent in many towns throughout the United States and other countries. In many instances, the criminals in the home invasion will quickly locate the safe and demand that the homeowner open it at gunpoint. Even if the homeowner has multiple safes, they are usually easy to locate and, therefore, a homeowner is not always successful in attempting to use one safe as a decoy while hiding more valuable items in another safe.

Despite the increased level of security that safes provide for preventing theft of valuables, there still exists a need for a more secure safe which is adapted to be installed in a location which is easy to access and yet which remains camouflaged from normal view. More particularly, there exists a need for a safe which can be easily installed in a convenient location and which is hidden from view so that thieves cannot find it.

### SUMMARY OF THE INVENTION

The present invention is directed to a hidden safe which includes a housing with an open end and a sliding drawer received within the housing. A front panel on the drawer covers the open end of the housing when the drawer is closed. A concealed key switch provides power from a battery power source to a hidden push button switch. The push button switch is operable to deliver electric power to a solenoid mounted within the housing. Momentary activation of the solenoid causes a catch pin to retract and release the drawer from a locked position. Once released, a spring urges the drawer outwardly from the open end of the housing to an extended, open position, thereby providing access to contents stored in the drawer. Movement of the drawer to the closed position compresses the spring and engages the catch pin with an aperture in a tab extending from a back of the drawer, thereby holding the drawer in the locked position.

### BRIEF DESCRIPTION OF THE DRAWINGS

For a fuller understanding of the nature of the present invention, reference should be made to the following detailed description taken in conjunction with the accompanying drawings in which:

FIG. 1 is a front top perspective view of the drawer safe shown with the drawer in an extended, open position;

FIG. 2 is a top, front perspective view of the housing, shown assembled with the top shell and floor attached;

FIG. 3 is a top, front perspective view of the drawer of the safe;

FIG. 4 is an isolated top plan view, in partial section, showing a solenoid and catch pin assembly at the rear interior of the housing, with the catch pin in a locked position to hold the drawer closed and locked within the housing;

FIG. 5 is an isolated top plan view of the solenoid and catch pin assembly;

FIG. 6 is a top, front perspective view showing the hidden drawer safe of the present invention installed below a kitchen cabinet with the drawer in an open position;

FIG. 7 is a front perspective view showing the drawer of the installed safe of FIG. 6 in a closed position, wherein the entire safe is hidden from view below the kitchen cabinet and behind a section of baseboard; and

FIG. 8 is a schematic diagram of the power circuit for operating the solenoid.

Like reference numerals refer to like parts throughout the several views of the drawings.

### DETAILED DESCRIPTION OF THE PREFERRED EMBODIMENTS

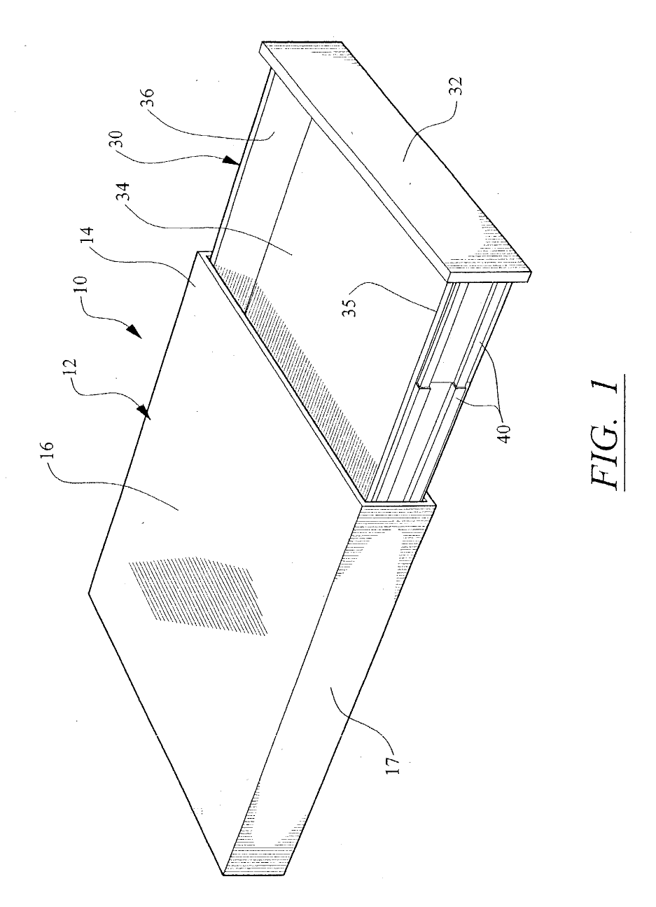

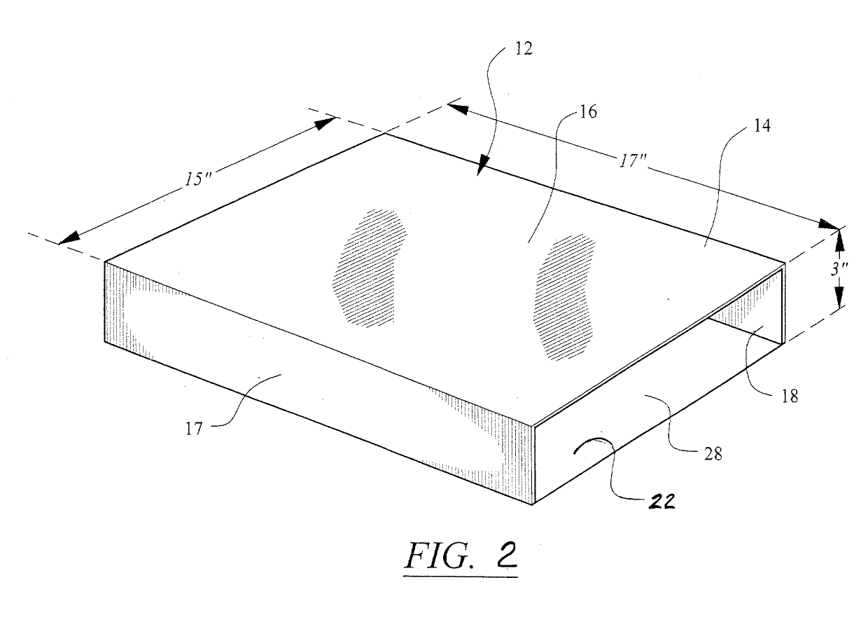

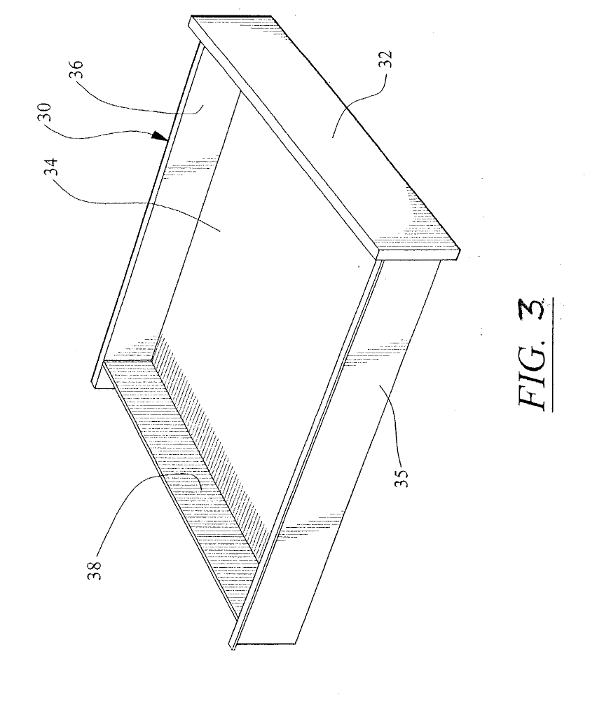

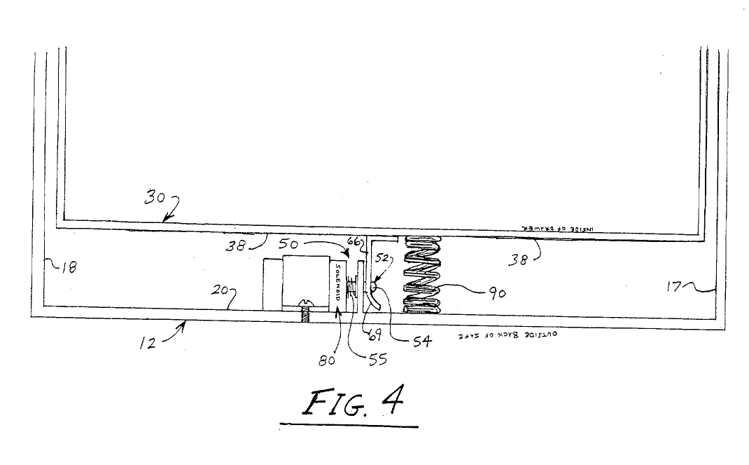

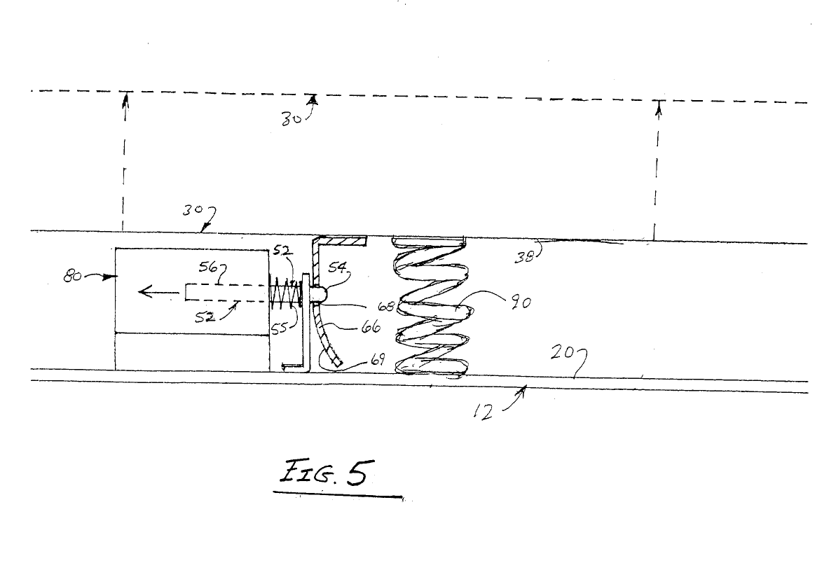

Referring to the several views of the drawings, and initially FIGS. 1-5, the hidden drawer safe of the present invention is shown and is generally indicated as 10. The hidden drawer safe includes a housing 12 having a top shell 14 and a floor 22. The top shell includes a top panel 16, opposite side panels 17 and 18, and a rear panel 20. In manufacture, the top shell is stamped from a flat sheet of material, such as steel, aluminum, or durable plastic, and is subsequently formed by bending the side panels and rear panel along the seams indicated by the broken lines in FIG. 2 to form the configuration shown in FIG. 4. The assembled housing 12 includes an open end 28 communicating with an interior chamber 26 that is surrounded by the panels of the top shell 14 and the floor 22. The safe 10 further includes a drawer 30 including a front panel 32, a bottom 34, opposite sides 35, 36, and a rear wall 38. The bottom and sides extend beyond the rear wall as seen in FIGS. 5-7. The drawer is slidably received through an open end 28 of the housing and is maintained on drawer slides 40 fitted to opposite outboard sides of the side walls 35, 36 of the drawer 30 and the inner sides of the side panels 17, 18 of the housing. The drawer slides 40 are very similar to that found on desk drawers which permit extension of the drawer relative to the housing to a fully open position. The drawer slides are structured to stop movement of the drawer at the fully extended open position so that it does not separate from the housing.

The drawer 30 is held closed in a locked position by a catch pin assembly 50 mounted to the inside rear wall 20 of the housing. In the locked position, the front panel 32 of the drawer covers the open end 28 of the housing to conceal the contents of the drawer within the housing. When locked closed, the combined housing and drawer assembly form a neat rectangular box configuration. The catch pin assembly 50 includes a catch pin 52 with a distal end portion 54. An opposite proximal end portion 56 of the catch pin 52 is received within an electric solenoid 80 mounted to the inside rear wall 20 of the housing 12. A catch member in the form of a tab 66 is attached to the rear wall 38 of the drawer and extends beyond the rear wall 38 of the drawer towards the back wall of the housing. The tab 66 includes an aperture 68 which is positioned and arranged for locking receipt and engagement with the distal end portion 54 of the catch pin 52 when the drawer 30 is pushed entirely within the housing 12 to the closed position, as seen in FIGS. 4 and 5. To open the drawer, the solenoid 80 is activated, causing the catch pin 52 to momentarily retract inward against an outward urging force of biasing element 55 so that the distal end portion 54 releases from the tab 66. This releases the drawer from locked engagement with the catch pin assembly 50, allowing a spring 90 mounted to the back wall 20 of the housing to push the drawer outwardly, relative to the front open end of the housing, so that the drawer moves to the extended, open position. This completes opening of the safe to permit access to the interior of the drawer so that valuables and other articles can be placed within and removed from the safe. Upon closing the drawer, the spring 90 is compressed and the distal end of the catch pin 52 engages a smooth curved surface 69 on the tab 66 to slightly retract the catch pin 52 while guiding the distal end of the catch pin into the aperture 68 in the tab on the back of the drawer. Once the distal end of the catch pin reaches the aperture 68, the biasing element 55 urges the catch pin to the fully extended position to lock the distal end portion within the aperture of the tab, thereby holding the drawer locked closed until subsequent actuation of the solenoid.

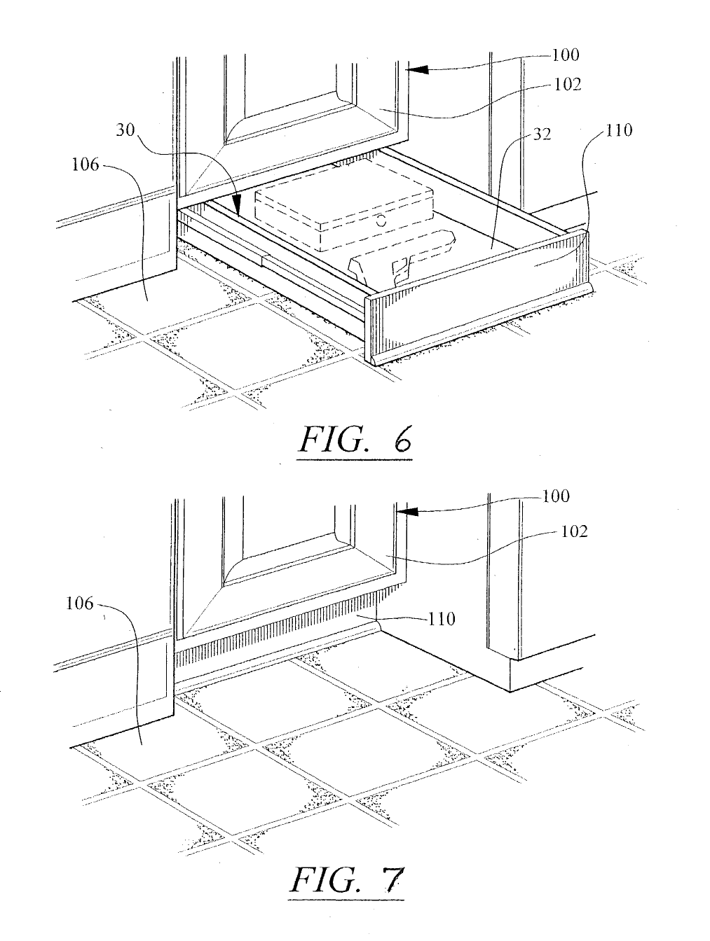

The hidden drawer safe 10 is specifically structured and disposed for mounting within confined, empty spaces in furniture, cabinets, walls and the like. To conceal the safe so that it is camouflaged from view, the front panel 32 of the drawer 30 is adapted for mounting of articles thereto, such as baseboard, trim, parts of furniture, etc. In this manner, when the drawer 30 is closed and in the locked position, the front panel 32 of the drawer, along with the entire safe 10, is hidden from view. An installation of the drawer safe 10 is shown in FIGS. 6 and 7, wherein the drawer safe is shown installed below a kitchen cabinet 100, between the cabinet 100 and the floor 106. In this instance, a section of baseboard 110 or trim below the cabinet door 102 is removed and the housing 12 of the safe 10 is installed within a cavity below the cabinet 100. Once the safe is installed, the section of baseboard or trim 110 can be glued or otherwise attached to the outer exposed face of the front panel 32 of the drawer 30 so that the section of baseboard 110 actually becomes part of the drawer 30. When the drawer is closed and locked, the section of baseboard 110 blends in with the cabinet 100 and surrounding structure, as seen in FIG. 7, so that the safe, including the drawer, is hidden from view.

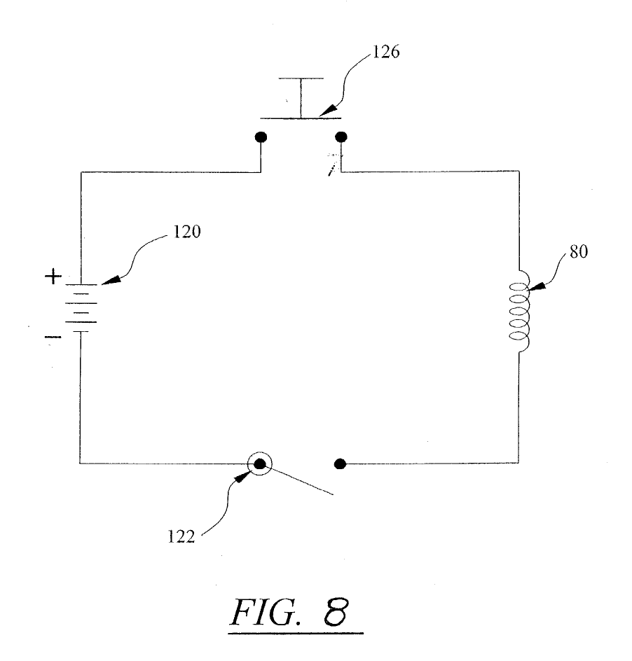

The solenoid 80 is operated by electric power upon actuation of a switch. Referring to FIG. 8, a circuit diagram is shown according to a preferred embodiment of the invention. Specifically, a battery power source 120 is provided to supply electric power to the solenoid 80. A key switch 122 is operable to an on position to activate the electric power supply to the solenoid. With the key switch 122 in the on (i.e. closed) position, a circuit completing power supply from the battery source 120 to the solenoid 80 is completed by momentary operation of a push button switch 126. Specifically, by depressing a hidden push button switch 126, power from the battery 120 is delivered to the solenoid 80 causing momentary retraction of the catch pin 52 and release of the catch pin assembly 50, as described above. For security purposes, the key switch 122 should be located in a hidden location away from the safe 10. Likewise, the push button switch 126 should be hidden in a separate hidden location away from the safe and the key switch 122. To complete installation, the key switch 122 and push button switch 126 are wired to the battery power source 120 and the solenoid 80, in a manner which hides the wiring connections and switches from view.

While the present invention has been shown and described in connection with a practical and preferred embodiment thereof, it is recognized that departures from the instant disclosure are contemplated within the spirit and scope of the present invention.

What is claimed is:

1. A safe for storing items comprising:
a housing including a rear wall with an inner surface, and an open end communicating with an interior chamber;
a drawer slidably received within said interior chamber of said housing an outwardly extendable from said open end of said housing, said drawer being structured for placement of the items therein and including a bottom, a front panel and a back panel with an exterior side, and said drawer being operable between a closed position wherein said front panel is covering said open end of said housing to completely enclose said interior chamber, and an open position wherein said front panel is moved away from said open end to permit access to the items placed in the drawer;
a catch pin assembly for releasably holding the drawer locked in said closed position and said catch pin assembly including:
a catch pin including a proximal end zone and a distal end zone, and said catch pin being operable between an extended locking position and a retracted release position;
a solenoid mounted to an interior of said housing and operatively positioned between said rear wall of said housing and said back panel of said drawer, said proximal end zone of said catch pin extending within said solenoid, and said solenoid being structured and disposed for momentarily retracting said catch pin to said release position;
a biasing element for urging said catch pin to said extended locking position; and
a catch member extending from said exterior side of said back panel of said drawer and said catch member being structured and disposed for locking engagement with said distal end zone of said catch pin when said catch pin is urged to said extended locking position, and said catch member including a surface for engaging said distal end zone of said catch pin to guide said catch pin into locking engagement with said catch member upon movement of said drawer from said open position to said closed position; and
a switch for activating said solenoid in order to operate said catch pin assembly and momentarily retract said catch pin to said release position, thereby releasing said drawer from said locked position.

2. The safe as recited in claim 1 wherein said solenoid is activated by electrical power delivered from an electrical power source.

3. The safe as recited in claim 2 wherein said switch is operable between a normally open position to interrupt the supply of electrical power to said solenoid and a closed position to direct the supply of electrical power from said electrical power source to said solenoid for activation thereof and momentary retraction of said catch pin to said release position.

4. The safe as recited in claim 3 wherein said switch includes a first switch operatively connected between said electrical power source and said solenoid and a second switch operatively connected between said electrical power source and said solenoid.

5. The safe as recited in claim 4 wherein:
said first switch is a key activated switch;
said second switch is a momentary switch; and
wherein activation of said solenoid requires operation of said key activated switch to said closed position and operation of said momentary switch to said closed position.

6. The safe as recited in claim 1 further comprising:
a spring element for urging said drawer to said open position upon activation of said solenoid and retraction of said catch pin to said release position.

7. A safe for storing items comprising:
a housing including a rear wall with an inner surface, and an open end communicating with an interior chamber;
a drawer slidably received within said interior chamber of said housing an outwardly extendable from said open end of said housing, said drawer being structured for placement of the items therein and including a bottom, a front panel and a back panel with an exterior side, and said drawer being operable between a closed position wherein said front panel is covering said open end of said housing to completely enclose said interior chamber, and an open position wherein said front panel is moved away from said open end to permit access to the items placed in the drawer;
a catch pin assembly for releasably holding the drawer locked in said closed position and said catch pin assembly including:
a catch pin including a proximal end zone and a distal end zone, and said catch pin being operable between an extended locking position and a retracted release position;
a solenoid mounted to an interior of said housing and operatively positioned between said rear wall of said housing and said back panel of said drawer, said solenoid being activated by electrical power delivered from an electrical power source, said proximal end zone of said catch pin operatively coupled to said solenoid, and said solenoid being structured and disposed for momentarily retracting said catch pin to said release position;
a biasing element for urging said catch pin to said extended locking position; and
a catch member extending from said exterior side of said back panel of said drawer and said catch member being structured and disposed for locking engagement with said distal end zone of said catch pin when said catch pin is urged to said extended locking position, and said catch member including a surface for engaging said distal end zone of said catch pin to guide said catch pin into locking engagement with said catch member upon movement of said drawer from said open position to said closed position;
a switch operable between a normally open position to interrupt the supply of electrical power to said solenoid and a closed position to direct the supply of electrical power from said electrical power source to said solenoid for activation thereof in order to operate said catch pin assembly and momentarily retract said catch pin to said release position, thereby releasing said drawer from said locked position; and
a spring element for urging said drawer to said open position upon activation of said solenoid and retraction of said catch pin to said release position.

8. The safe as recited in claim 7 wherein said switch includes a first switch operatively connected between said electrical power source and said solenoid and a second switch operatively connected between said electrical power source and said solenoid.

9. The safe as recited in claim 8 wherein:
said first switch is a key activated switch;
said second switch is a momentary switch; and
wherein activation of said solenoid requires operation of said key activated switch to said closed position and operation of said momentary switch to said closed position.
